(19) United States
(12) Patent Application Publication
(10) Pub. No.: US 2007/0065537 A1
(43) Pub. Date: Mar. 22, 2007

(54) Injection molding valve gate having combined sealing and guiding structures

(75) Inventor: Vince Ciccone, Kleinburg (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Injectnotech Inc., Mississauga (CA)

(21) Appl. No.: 11/522,054

(22) Filed: Sep. 15, 2006

Related U.S. Application Data
(60) Provisional application No. 60/717,614, filed on Sep. 16, 2005.

(51) Int. Cl. B29C 45/17

(52) U.S. Cl. 425/564

(57) ABSTRACT

A valve gate unit for an injection molding machine, configured to be in surface contact with a manifold of an injection molding machine for delivering a molten plastic flow from a hot runner system to an injection chamber mold cavity. The valve gate unit has a valve stem for controlling the flow of the molten plastic from a hot runner system to an injection chamber mold cavity, and a seal pack having a stem housing, an inner seal and a threaded seal retainer, the seal pack being removable as a single unit while the mold is in the injection molding machine, wherein the stem housing is fixed in relation to the valve gate unit, and wherein the threaded seal retainer holds the inner seal inside the stem housing, and wherein the valve stem slides through the stem housing and the inner seal as the valve gate is opened and closed.

### CROSS-REFERENCES TO RELATED APPLICATIONS

The present application claims priority to U.S. Provisional Patent Application No. 60/717,614, filed on Sep. 16, 2005, and is related to U.S. patent application Ser. No. 10/938,787, filed on Sep. 9, 2004, the teachings of which are incorporated herein by reference in their entirety for all purposes, not inconsistent with the present disclosure.

### BACKGROUND OF THE INVENTION

The present invention relates to valve gate systems for injection molding machines, for controlling the injection of molten plastic into a mold chamber, and in particular to improved sealing structures housed in the valve gate unit, which, besides sealing, also guide the extend-retract motion of the movable unit of the valve gate.

### BRIEF SUMMARY OF THE INVENTION

The present invention is directed towards valve gate systems for injection molding machines, for controlling the injection of molten plastic into a mold chamber, and in particular to improved sealing structures housed in the valve gate unit. The improved sealing structures include subassemblies housed in the valve gate unit, which, besides sealing, also guide the extend-retract motion of the movable unit as actuated by an activating bar, through a yoke.

In one embodiment, the present invention provides a valve gate unit for an injection molding machine, configured to be in surface contact with a manifold of an injection molding machine for delivering a molten plastic flow from a hot runner system to an injection chamber mold cavity. The valve gate unit has a valve stem for controlling the flow of the molten plastic from a hot runner system to an injection chamber mold cavity, and a seal pack having a stem housing, an inner seal and a threaded seal retainer, the seal pack being removable as a single unit while the mold is in the injection molding machine, wherein the stem housing is fixed in relation to the valve gate unit, and wherein the threaded seal retainer holds the inner seal inside the stem housing, and wherein the valve stem slides through the stem housing and the inner seal as the valve gate is opened and closed.

For a further understanding of the nature and advantages of the invention, reference should be made to the following description taken in conjunction with the accompanying drawings. The drawings described below are merely exemplary drawings of various embodiments of the present invention which should not limit the scope of the disclosure and claims herein. One of ordinary skill would recognize many variations, alternatives, and modifications. These variations, alternatives, and modifications are intended to be included within the scope of the present invention, which is described herein.

### BRIEF DESCRIPTION OF THE DRAWINGS

FIG. 1 is an exemplary cross-sectional view diagram through a first embodiment of the valve gate system in accordance with the present invention, shown with the movable unit extended (valve stem extended to close the gate).

FIG. 1a is a cross-sectional view diagram of the valve gate system of FIG. 1, shown with the movable unit retracted (valve stem retracted to open the gate).

FIG. 2 is an exemplary cross-sectional view diagram through a second embodiment of the valve gate system in accordance with the present invention, shown with the movable unit extended (valve stem extended to close the gate).

FIG. 2a is a cross-sectional view diagram of the valve gate system of FIG. 2, shown with the movable unit retracted (valve stem retracted to open the gate).

FIG. 3 is an exemplary cross-sectional view diagram through a third embodiment of the valve gate system in accordance with the present invention, shown with the movable unit extended (valve stem extended to close the gate).

FIG. 3a is a cross-sectional view diagram of the valve gate system of FIG. 3, shown with the movable unit retracted (valve stem retracted to open the gate).

FIG. 4 is an exemplary cross-sectional view diagram through a fourth embodiment of the valve gate system in accordance with the present invention, shown with the movable unit extended (valve stem extended to close the gate).

FIG. 4a is a cross-sectional view diagram of the valve gate system of FIG. 4, shown with the movable unit retracted (valve stem retracted to open the gate).

### DETAILED DESCRIPTION OF THE INVENTION

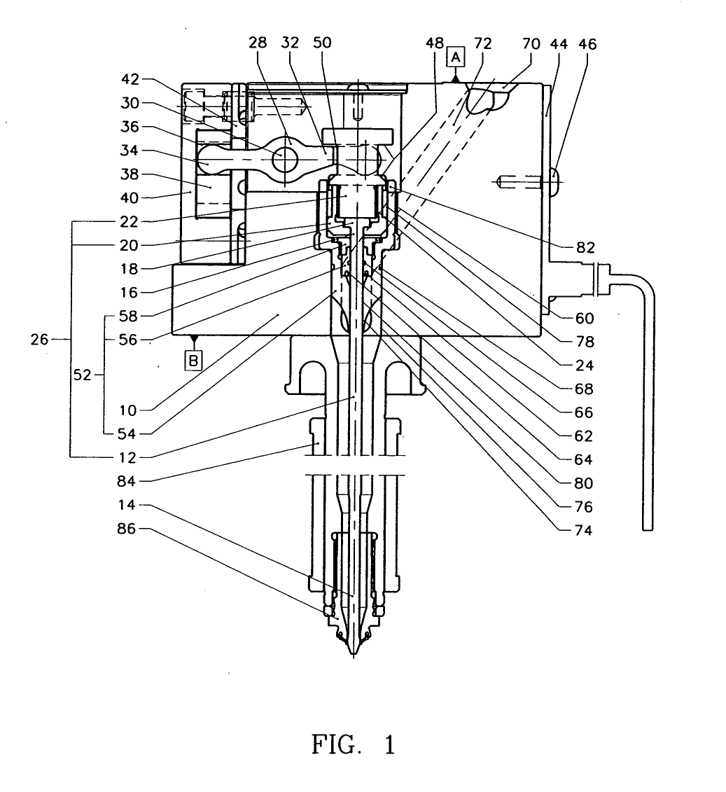

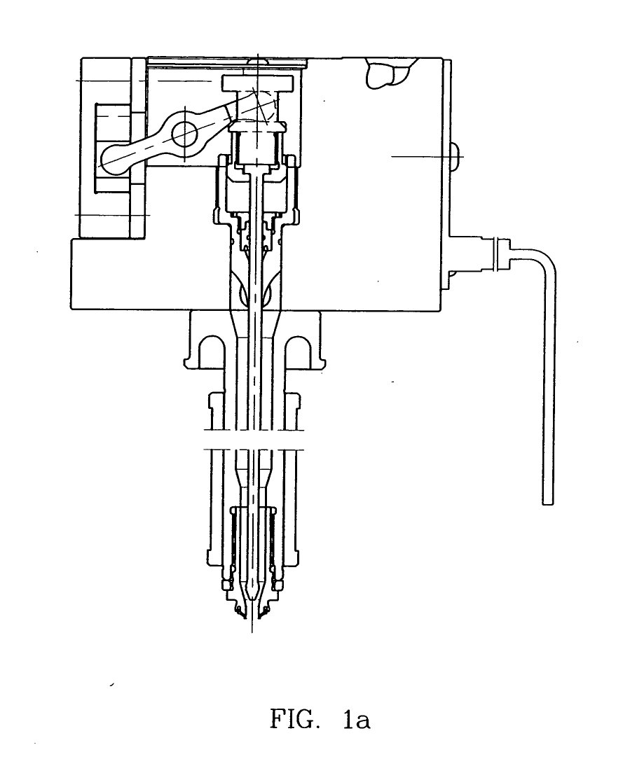

A first embodiment of the present invention as shown in FIG. 1 presents a valve gate unit 10. The valve gate units 10, as shown in FIGS. 1, 2, 3, and 4 can be activated by an activating system as described in U.S. patent application Ser. No. 10/938,787, the teachings of which are incorporated herein by reference in their entirety for all purposes, not inconsistent with the present disclosure. The valve gate unit 10 is in surface contact (at surface A) with the manifold (not shown) without use of fasteners, such that the manifold could have unlimited lateral thermal expansion without causing deflection and/or other loss of position of valve stem 12. The valve gate unit 10 is supported at surface B and partially around the sides by a cooled mold plate such as a cavity plate (not shown), which ensures that locational precision of the valve gate unit is strictly maintained.

The valve stem 12 has a front end 14 (adjacent the gate and mold cavity, both not shown) and a back end 16 (inside the valve gate unit 10). The back end 16 of the first embodiment of this invention is preferably provided with an enlarged portion or head 18. Due to head 18, the valve stem 12 of this embodiment is installed from the back and centered in a flange housing 20, being secured against separation (from flange housing) by an extend-return cap 22 which may preferably have a threaded engagement 24 with the flange housing 20. The valve stem 12, flange housing 20 and extend-return cap 22 form a movable unit 26, which extends and returns to respectively close and open the valve gate, as activated by a yoke 28. Yoke 28 can pivot about a pivot pin 30 that is fixedly secured in body of valve gate unit 10.

Not unlike the yoke design of U.S. patent application Ser. No. 10/938,787, yoke 28 has a forked end 32 and an opposite spherical end 34. The spherical end 34 is guided by the activating profile 36 of an activating bar 38, which extends from the activating system (not shown) mounted externally, through the mold, to the valve gate unit(s). A cover cap 40, secured with fasteners to a side of the valve gate unit 10, guides the extend-retract motion of the activating bar 38. A thermal plate 42, installed between cover cap 40 and valve gate unit 10, prevents heat transfer (heat loss) from the valve gate unit 10, which is heated by a wrap-around heater 44 (secured with fasteners 46 to valve gate unit 10) to the activating bar 38 and cover cap 40. It should be understood that other heating element types can be employed to heat the valve gate unit, such as for example cartridge heaters (not shown).

The forked end 32 of yoke 28 actuates the extend-return cap 22, by alternately acting onto the flat top and bottom surfaces 48. These flat surfaces are connected by a reduced portion 50, which is centered between the two prongs of the forked end 32.

The novel sealing structures in accordance with the embodiments of the present invention include a seal pack 52 comprising a stem housing 54, an inner seal 56 and a threaded seal retainer 58. The stem housing 54 is fixed in relation to the valve gate unit 10, preferably by (but not limited to) threaded engagement 60. The threaded seal retainer 58 holds the inner seal 56 inside the stem housing 54. As can be further seen in FIG. 1, the valve stem 12 slides through the stem housing 54 and inner seal 56 as the valve gate is alternately opened and closed. The inner seal 56 has an annular groove 62 at the front end, which leaves a circular portion surrounding the valve stem 12 to act as a wiper 64 as the valve stem retracts to open the valve gate. The molten plastic removed by wiper 64 collects in annular groove 62, putting pressure all around the wiper 64 and causing it to effect a stronger sealing action onto the valve stem 12. An internal collector groove 66 of the inner seal 56 provides additional sealing. Similarly, the stem housing 54 has an external collector groove 68 designed to collect plastic leaks between the stem housing 54 and the valve gate unit bore.

In operation, molten plastic is directed from the manifold (not shown) to a singular inlet 70 at surface A of the valve gate unit 10. From there on, plastic is separated into two symmetrical flow lines 72, then re-merged around the thin active end 74 of stem housing 54, flowing around valve-stem 12 until it reaches the valve gate and is injected into the molding cavity (not shown). The thin active end 74 of stem housing 54, besides allowing room for the plastic of flow channels 72 to blend, also acts as a wiper during retraction of the valve stem 12, to further prevent seepage inside the improved sealing means described above.

Appropriate axial alignment of valve stem 12 in reference to bore 76 of valve gate unit 10 is achieved by stem housing 54. Stem housing 54, secured inside valve gate unit 10 by threaded engagement 60 (or by other suitable securing means) and effectively centered in position by bore 76, doubly guides the movable unit 26 as it extends and returns: cylindrical back inner surface 78 guides motion of flange housing 20 (which securely aligns valve stem back end 16), while front inner surface 80 guides motion of valve stem 12. This prevents possible destabilizing forces (such as lateral friction forces of forked end 32 of yoke 28) from causing the valve stem to deflect from its desired axial position.

Inner seal 56 can be made of a material having low friction, and/or a high strength and durability, and/or a high creep resistance, and/or a high resistance to wear and high temperatures. The normal operating temperatures for the valve gate system are typically between 400° F. to 700° F. depending on specific case requirements, but could be varied below or over this range. The inner seal should preferably be able to operate at high pressure in a non-lubricated medium. Non-metallic materials such as ceramics and/or polymers VESPEL, MELDIN, RULON, thermoplastic Celazole® PBI, or metallic materials with similar characteristics, such as titanium, may be used for the inner seal based on specific requirements. It should be understood that other materials, having the attributes listed above, can be used for the inner seal without departing from the scope of the disclosure.

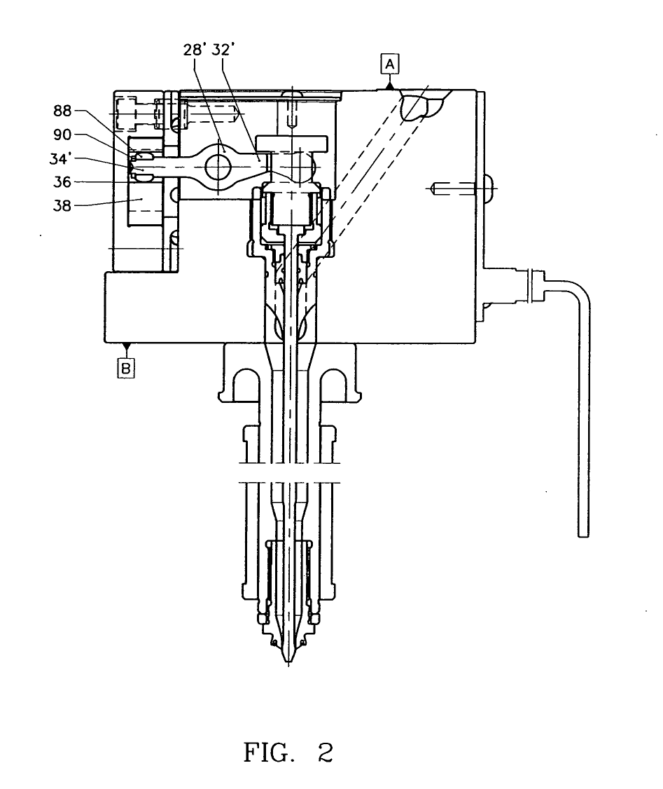

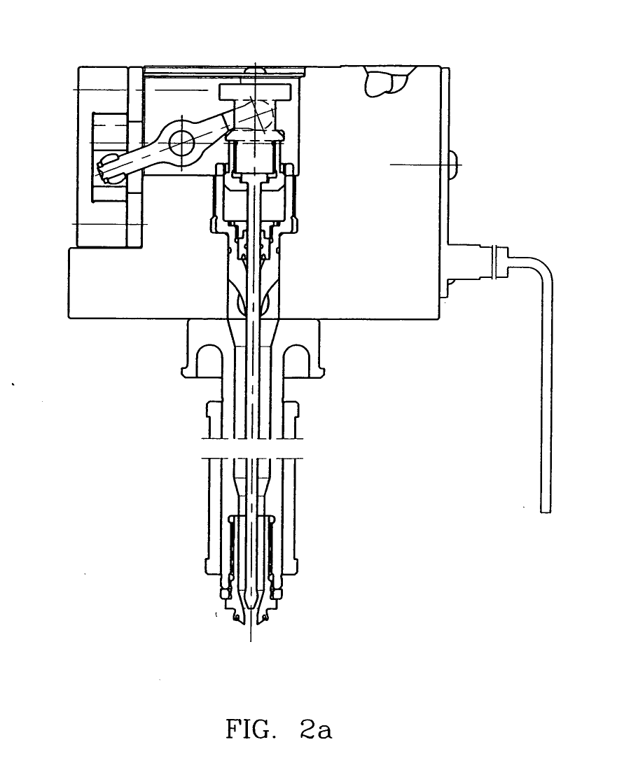

An advantage of this design as well as the alternative embodiments shown in FIGS. 2, 3, and 4 is that the valve gate system can be serviced in the mold, while the mold is in the injection press. That is, it is not necessary to remove the valve gate system from the mold. This simplifies maintenance and reduces machine downtime. A further advantage is the cost-effective design of the seal pack 52, which can be removed as a singular unit, by applying a custom torque wrench (not shown) to slots 82 on back end of stem housing 54. The seal pack 52 can be preassembled and stored as a subassembly enabling its efficient storage and installation.

The nozzle unit 84 shown in FIG. 1 can be used with a variety of nozzle tips 86, such as those disclosed in the applicant's U.S. patent application Ser. No. 10/934,544, filed on Sep. 3, 2004, and U.S. Provisional Patent Application Nos. 60/630,266, filed on Nov. 22, 2004, continued as U.S. patent application Ser. No. 11/286,266, and 60/641,219, filed on Dec. 30, 2004, continued as U.S. patent application Ser. No. 11/319,757, and U.S. Provisional Patent Application No. 60/694,642, filed on Jun. 27, 2005 and continued as U.S. patent application Ser. No. 11/476,412.

A second embodiment of the present invention, shown in FIG. 2, uses a yoke 28′, having a different end 34′ onto which a rotatable sleeve 88 is centered. A retainer 90 helps prevent the rotatable sleeve 88 from becoming detached from end 34′ of yoke 28′, while allowing sufficient clearance for it to rotate freely around end 34′, thus letting it act as a bearing. An advantage of this embodiment is that yoke 28′ can be made of a material of high strength and/or high resistance to fatigue, whereas the rotatable sleeve 88 can be made of a material with high wear-resistance. The outer surface of rotatable sleeve 88 mimics the shape of the spherical end 34 of yoke 28 of the first embodiment. A further advantage of this design is that by incorporating a bearing feature into the yoke, contact between activating profile 36 of activating bar 38 and yoke 28′ is a rolling contact and not a strictly friction contact. This helps reduce the influence of any lateral destabilizing forces onto the yoke, thus extending the life and precision of the entire valve gate system.

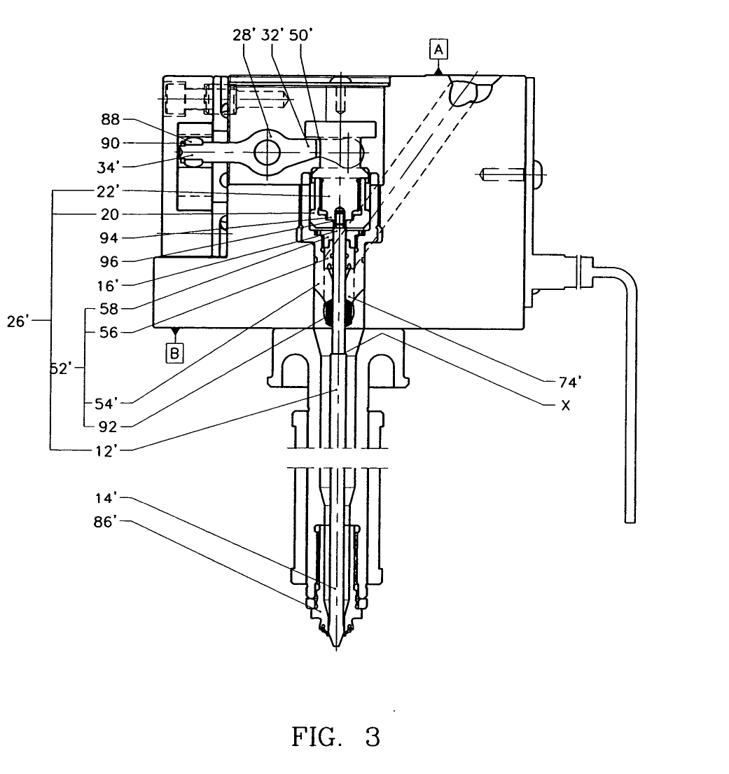

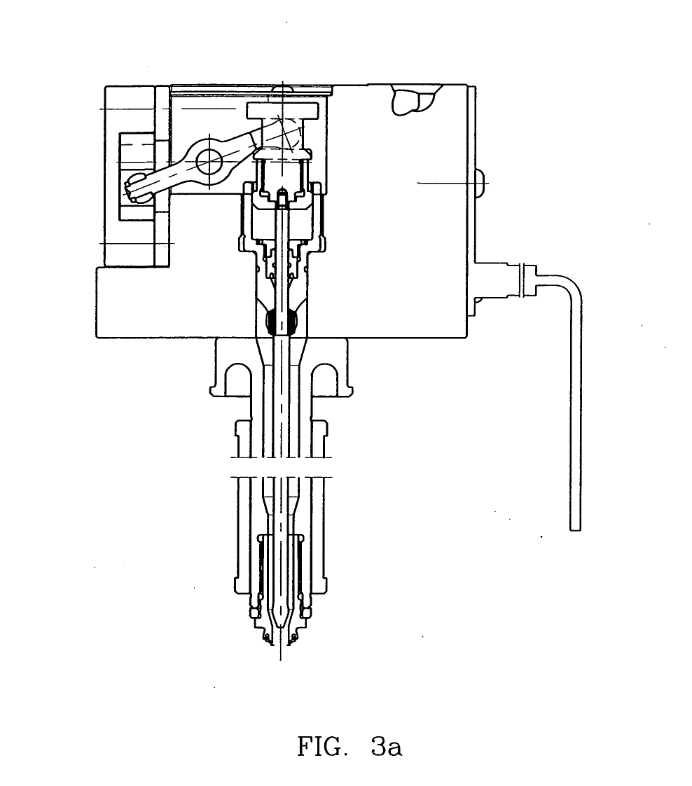

A third embodiment of the present invention, shown in FIG. 3 with the modified yoke 28′ of the second embodiment (but which could instead use the conventional yoke 28 of the first embodiment) presents a modified valve stem 12′, having a front end 14′ having a larger diameter than back end 16′, designed to accommodate a tubular seal 92 at the front of the seal pack. Modified for the same purpose is stem housing 54′, which has the thin front portion removed, having the remaining active end 74′ shaped to allow surface contact with tubular seal 92. Seal 92 is attached to the modified active end 74′ of stem housing 54′, staying in contact with stem housing 54′ regardless of the extended or retracted position of the valve stem 12′. Valve stem 12′ is designed such that, when movable unit 26′ is fully retracted (valve gate is fully open), the valve stem shoulder X, formed where the larger diameter of the front end 14′ starts, comes in firm contact with the front end of tubular seal 92, to effect a positive sealing action and prevent seepage of molten plastic into the seal pack 52′ as shown in FIG. 3a.

This embodiment can have a modified extend-return cap 22′, having a portion 94 extending towards back end 16′ of modified valve stem 12′. Since this third embodiment uses the same flange housing 20 as the previous two embodiments, portion 94 is shaped to fill the space previously provided for the enlarged head 18 of the valve stem 12 of the first and second embodiments. Furthermore, because of the diametric difference between front end 14′ and back end 16′, modified valve stem 12′ of the third embodiment requires installation from the front (from the gate side) and is secured to portion 94 of modified extend-return cap 22′ preferably by threaded engagement 96 as shown in FIG. 3, but other suitable securing means are considered and could be employed.

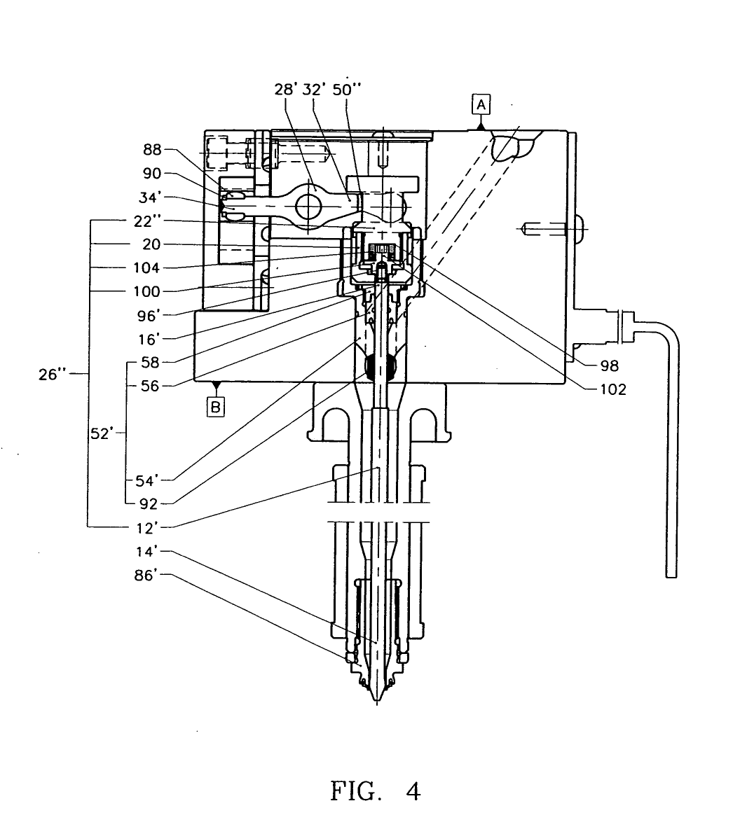

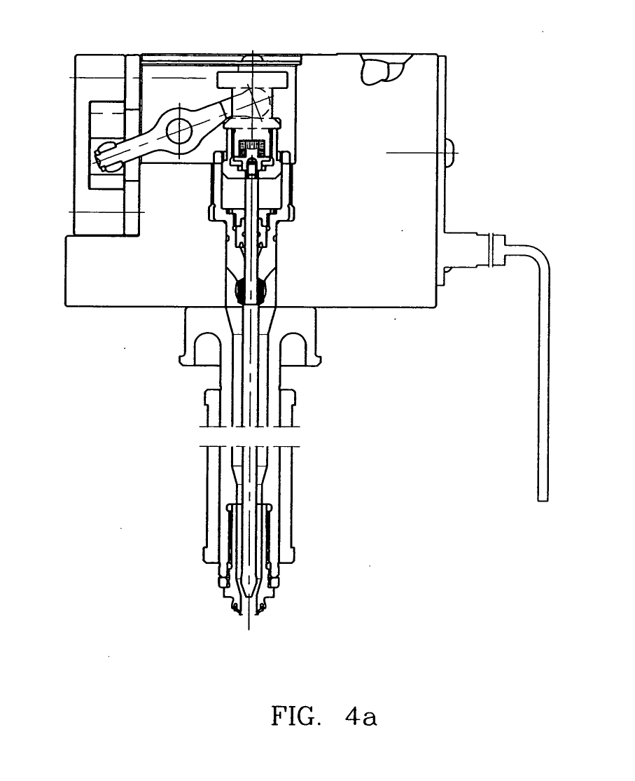

A fourth embodiment is shown in FIG. 4 with modified yoke 28′. However a conventional yoke 28 can also be used with the embodiment depicted in FIG. 4. This embodiment employs the modified valve stem 12′ with tubular seal 92 described above. As shown in FIG. 4, the extend-return cap 22″ has a pocket 98 towards back end 16′ of the modified valve stem 12′. An additional piece in the shape of a flanged connector 100 is employed; back end 16′ of modified valve stem 12′ is secured to flanged connector 100 by threaded engagement 96′ (or by other suitable means). At the opposite end, flanged connector 100 has a rod portion 102 that centers a pack of spring washers 104 into pocket 98 of the extend-return cap 22″. Spring washers 104 are installed with a controlled amount of preload, to urge the valve stem 12′ against valve gate (when closed), to better seal against drool at the gate. Spring washers 104 can be installed in series (to increase the deflection) and/or in parallel (to increase the load).

It should be understood that the second, third and fourth embodiments can be used with the nozzle unit 84 and various nozzle tips 86′ similar to nozzle tips 86 described in the first embodiment.

An alterative embodiment is related to the contact between yoke 28 and extend-return cap 22 (or modified yoke 28′ and modified extend-return caps 22′ or 22″). Where FIGS. 1 through 4 show a forked end 32 (32′) of yoke 28 (28′) having prongs on opposite sides of reduced portion 50 (50′, 50″) of extend-return cap 22 (22′, 22″) and acting on flat top and bottom surfaces 48 (48′, 48″), an alternate design is considered where the two offset prongs of the forked end 32 (32′) are replaced by a singular, central prong of similar cross-section, the singular prong acting alternately on the top and bottom surfaces of a central, suitably-shaped pocket in the reduced portion 50 (50′, 50″) of extend-return cap 22 (22′ and 22″ respectively).

Furthermore, the spring pack 140 of the fourth embodiment can also be used in the design of the first and second embodiments with the spring washers acting onto head 18 of valve stem 12.

Similar to the design of U.S. patent application Ser. No. 10/938,787, multiple valve gate units can be installed in series, to be activated by a single, externally mounted activating system. Furthermore, the four embodiments presented allow back-to-back installation for stack molds.

Further details related to components, features (e.g., such as those of the activating system and activating bar) and methods (e.g., such as installation, adjustment of activating system or maintenance while in the injection machine) related to the embodiments of the present invention are described in detail in U.S. patent application Ser. No. 10/938,787.

As will be understood by those skilled in the art, the present invention may be embodied in other specific forms without departing from the essential characteristics thereof. For example, the novel features of the embodiments of the present invention described above can be combined into a single hybrid embodiment, or may each be individually incorporated into a suite of novel valve gate configurations. These other embodiments are intended to be included within the scope of the present invention, which is set forth in the following claims.

What is claimed is:

1. A valve gate unit for an injection molding machine, configured to be in surface contact with a manifold of an injection molding machine for delivering a molten plastic flow from a hot runner system to an injection chamber mold cavity, the valve gate unit comprising:
a valve stem for controlling the flow of the molten plastic from a hot runner system to an injection chamber mold cavity; and
a seal pack comprising a stem housing, an inner seal and a threaded seal retainer, the seal pack being removable as a single unit while the mold is in the injection molding machine,
wherein the stem housing is fixed in relation to the valve gate unit, and
wherein the threaded seal retainer holds the inner seal inside the stem housing, and wherein the valve stem slides through the stem housing and the inner seal as the valve gate is opened and closed.

2. The valve gate unit of claim 1 wherein the stem housing is fixed in relation to the valve gate unit by a threaded engagement.

3. The valve gate unit of claim 1 wherein the inner seal has an annular groove at its front end, which leaves a circular portion surrounding the valve stem, configured to act as a wiper as the valve stem retracts to open the valve gate, so that molten plastic removed by the wiper collects in the annular groove, thus putting pressure around the wiper and causing it to form a seal onto the valve stem.

4. The valve gate unit of claim 1 wherein the inner seal has an internal collector groove, wherein the internal collector groove of the inner seal forms an additional seal against the valve stem.

5. The valve gate unit of claim 1 wherein the stem housing has an external collector groove configured for collecting plastic leaks between the stem housing and the valve gate unit bore.

6. The valve gate unit of claim 1 further comprising a flange housing and an extend-return cap, wherein the valve stem is centered in the flange housing, and secured against separation from the flange housing by the extend-return cap.

7. The valve gate unit of claim 6 wherein the extend-return cap has a threaded engagement with the flange housing.

8. The valve gate unit of claim 6 wherein the valve stem, the flange housing and the extend-return cap form a movable unit and
wherein the stem housing is configured to provide a double guiding effect onto the movable unit, wherein
a first guiding effect is provided onto the valve stem at the stem housing front inner surface and
a second guiding effect is provided onto the flange housing at the stem housing back inner surface.

9. The valve gate unit of claim 6 wherein the valve stem, the flange housing and the extend-return cap form a movable unit, wherein the movable unit extends and returns to respectively close and open the valve gate, as activated by a yoke.

10. The valve gate unit of claim 9 wherein the yoke comprises a rotatable sleeve acting as a bearing, configured for reducing lateral forces from being transferred through the yoke, to the movable unit and the seal pack.

11. The valve gate unit of claim 9 wherein the yoke pivots about a pivot pin that is secured in the body of the valve gate unit.

12. The valve gate unit of claim 9 wherein the yoke has a forked end and an opposite spherical end, wherein the spherical end is guided by the activating profile of an activating bar, which extends from the activating system mounted externally, through the mold, to the valve gate unit, and wherein a cover cap, secured with fasteners to a side of the valve gate unit, guides the extend-retract motion of the activating bar.

13. The valve gate unit of claim 12 wherein the forked end of the yoke has prongs on opposite sides of a reduced portion of the extend-return cap and the prongs act upon the flat top and bottom surfaces of the extend-return cap.

14. The valve gate unit of claim 9 wherein the yoke has a central prong end and an opposite spherical end, wherein the spherical end is guided by the activating profile of an activating bar, which extends from the activating system mounted externally, through the mold, to the valve gate unit, and wherein a cover cap, secured with fasteners to a side of the valve gate unit, guides the extend-retract motion of the activating bar.

15. The valve gate unit of claim 14 wherein the central prong is configured to act on the top and bottom surfaces of a central, suitably-shaped pocket in the reduced portion of the extend-return cap.

16. The valve gate unit of claim 6 wherein the extend-return cap has a pocket towards the back end of the valve stem, and a spring pack located on the back end of the valve stem that is biased against the pocket, wherein the spring pack is installed with a controlled amount of preload, to urge the valve stem against valve gate when closed, so as to seal against drool at the gate.

17. The valve gate unit of claim 16 wherein the spring pack comprises spring washer that are in series.

18. The valve gate unit of claim 16 wherein the spring pack comprises spring washer that are in parallel.

19. The valve gate unit of claim 1 further comprising a spring pack located on the valve stem.

20. The valve gate unit of claim 1 wherein the inner seal is made of a non-metallic material having low friction, high heat and wear resistance and high sealing capability.

21. The valve gate unit of claim 1 wherein the inner seal is made of a metallic material with low friction, high heat and wear resistance and high sealing capability.

22. The valve gate unit of claim 1 wherein the inner seal is an easily removable, replaceable and cost-effective component.

23. The valve gate unit of claim 1 wherein the valve stem has a front end of a larger diameter transitioning at a shoulder to a back end having a smaller diameter, the valve stem dimensioned to accommodate a tubular seal at the front of the seal pack.

24. The valve gate unit of claim 23 wherein the tubular seal is configured to be in contact with both the stem housing and the shoulder of the valve stem during injection.

25. The valve gate unit of claim 23 wherein the tubular seal is made of a material having a high wear and heat resistance and a high sealing capability.
